(19) United States
(12) Patent Application Publication
(10) Pub. No.: US 2007/0179793 A1
(43) Pub. Date: Aug. 2, 2007

(54) Method and apparatus for model-driven managed business services

(76) Inventors: Sugato Bagchi, White Plains, NY (US); Kumar Bhaskaran, Englewood Cliffs, NJ (US); Shiwa S. Fu, Irvington, NY (US); Ying Huang, Yorktown Heights, NY (US); Hai Tao Hu, Beijing (CN); Anca-Andreea Ivan, New Rochelle, NY (US); Shubir Kapoor, Shrub Oak, NY (US); Santhosh Kumaran, Croton on Hudson, NY (US); Luu Quoc Nguyen, Culver City, CA (US); Thejaswini Ramachandra, Yorktown Heights, NY (US)

Correspondence Address: Whitham, Curtis & Christofferson, P.C., Suite 340, 11491 Sunset Hills Road, Reston, VA, 20190, US

(21) Appl. No.: 11/333,065

(22) Filed: Jan. 17, 2006

(51) Int. Cl. G06Q 99/00; G06F 9/44; G05B 19/418

(52) U.S. Cl. 705/1; 705/7; 705/8

(57) ABSTRACT

A mechanism provides a model-driven solution template-based approach for managed business services. Key assets of the business services are templatized and made configurable. The mechanism implements a metamodel describing standard service offerings that can be configured to meet specific business and operational requirements at a level of business process and system components. A cost and pricing model of service offerings helps assess the service costs and resource requirements based on a client's selection of standard and customized processes and system components. A supporting system solution is developed based upon underlying solution templates and solution artifacts as well as client-specific requirements.

### BACKGROUND OF THE INVENTION

1. Field of the Invention

The present invention generally relates to the generation and delivery of managed business services and, more particularly, to a model-driven solution template-based approach for managed business services.

2. Background Description

With the advent of services-oriented architecture (SOA), there are a significant amount of business services being offered by service providers and consumed by service consumers (clients). One particular problem is, when adding a new client, how to understand the client's business and system environments and the requirements of those environments and, consequently, how to integrate the business processes and associated information technology (IT) systems between the two parties (the service provider and the service consumer). For most business services offered today, the entire process of adding a client (sometimes called the “on-boarding process”) is, for the most part, implemented manually. This creates several challenges for the service providers and consumers, including for example, long and costly service implementation and no systematic reuse of service assets.

### SUMMARY OF THE INVENTION

It is therefore an object of the invention to provide a method and apparatus which automate the on-boarding process of a new client of a service provider so as to provide systematic reuse of service assets and avoid long and costly service implementation.

According to the present invention, there is provided a model-driven solution template-based approach for managed business services. In this approach, the key assets of the business services will be template-based and made configurable. Key elements in a managed business service offering include:

Standard service offering (for example, by procure-to-pay or P2P) can be configured to meet the specific business and operational requirements at the level of business process and system components.

The cost and pricing of service offerings can be assessed based on the client's selection of standard and customized processes and system components.

The development of the supporting system solution will be based upon the underlying solution templates and solution artifacts as well as client-specific requirements.

The entire process of on-boarding/development/deployment will be streamlined and well-orchestrated for bringing onboard a new user of the service offering.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of a computer system on which the method according to the invention may be implemented;

FIG. 2 is a block diagram of a server used in the computer system shown in FIG. 1;

FIG. 3 is a block diagram of a client used in the computer system shown in FIG. 1;

FIG. 4 is a flow diagram showing the overall process implemented according to the invention;

FIG. 5 is a block diagram showing the interview template and related decision tree used to capture a client's requirements in the interview process;

FIG. 6 is a screen print showing the overall GUI screen a sample interview template;

FIG. 7 is a block diagram illustrating the supporting decision tree defined by an XML schema;

FIG. 8 is a data flow diagram showing the process of template-based solution development;

FIG. 9 is a data flow diagram showing the underlying models supporting the invention; and

FIG. 10 is a system diagram showing the various personnel and systems involved in a sample implementation of the invention.

### DETAILED DESCRIPTION OF A PREFERRED EMBODIMENT OF THE INVENTION

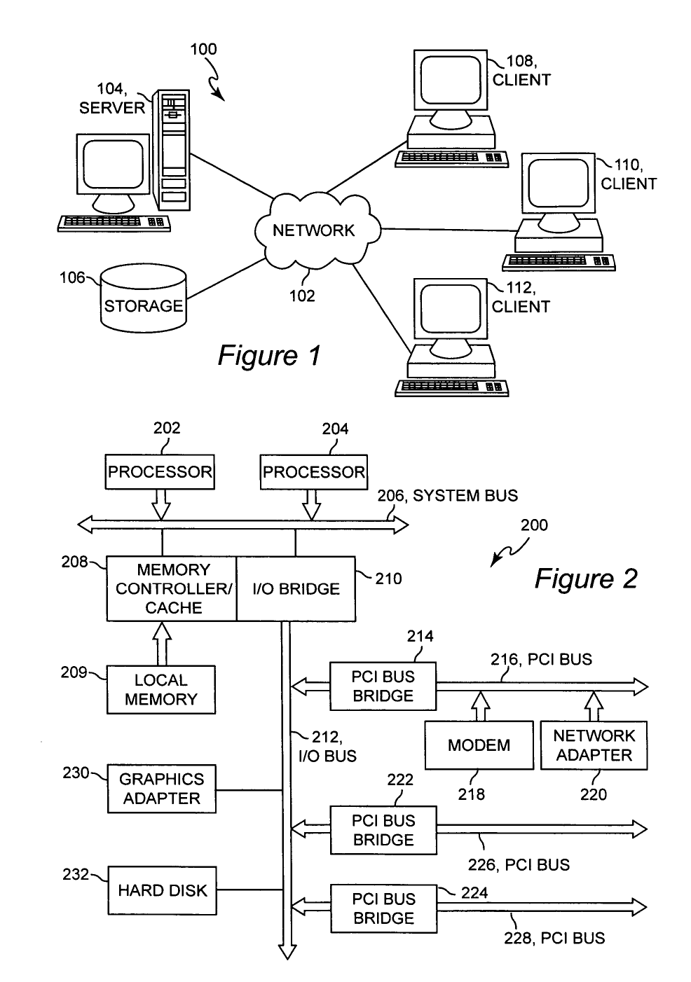

Referring now to the drawings, and more particularly to FIG. 1, there is shown a computer system on which the method according to the invention may be implemented. Computer system 100 contains a network 102, which is the medium used to provide communications links between various devices and computers connected together within computer system 100. Network 102 may include permanent connections, such as wire or fiber optic cables, wireless connections, such as wireless Local Area Network (WLAN) products based on the IEEE 802.11 specification (also known as Wi-Fi), and/or temporary connections made through telephone, cable or satellite connections, and may include a Wide Area Network (WAN) and/or a global network, such as the Internet. A server 104 is connected to network 102 along with storage unit 106. In addition, clients 108, 110 and 112 also are connected to network 102. These clients 108, 110 and 112 may be, for example, personal computers or network computers. For purposes of this application, a network computer is any computer, coupled to a network, which receives a program or other application from another computer coupled to the network. The server 104 provides data, such as boot files, operating system images, and applications to clients 108, 110 and 112. Clients 108, 110 and 112 are clients to server 104.

Computer system 100 may include additional servers, clients, and other devices not shown. In the depicted example, the Internet provides the network 102 connection to a worldwide collection of networks and gateways that use the TCP/IP (Transmission Control Protocol/Internet Protocol) suite of protocols to communicate with one another. At the heart of the Internet is a backbone of high-speed data communication lines between major nodes or host computers, consisting of thousands of commercial, government, educational and other computer systems that route data and messages. In this type of network, hypertext mark-up language (HTML) documents and applets are used to exchange information and facilitate commercial transactions. Hypertext transfer protocol (HTTP) is the protocol used in these examples to send data between different data processing systems. Of course, computer system 100 also may be implemented as a number of different types of networks such as, for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Server 200 may be used to execute any of a variety of business processes. Server 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. Input/Output (I/O) bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

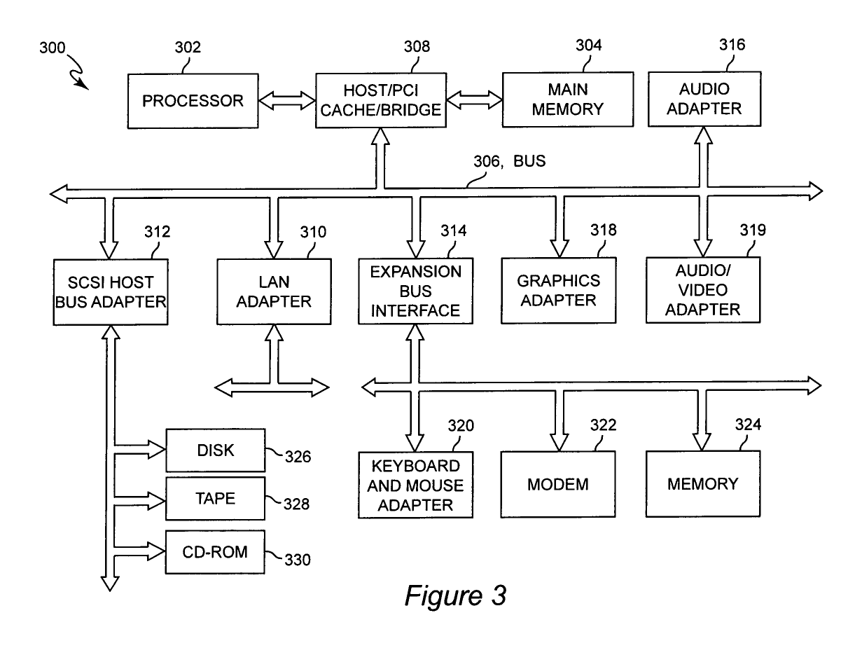

With reference now to FIG. 3, a block diagram illustrating a client computer is depicted in accordance with a preferred embodiment of the present invention. Client computer 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards.

In the depicted example, local area network (LAN) adapter 310, Small Computer System Interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object-oriented programming system such as Java may run in conjunction with the operating system and provides calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, and/or I/O devices, such as Universal Serial Bus (USB) and IEEE 1394 devices, may be used in addition to or in place of the hardware depicted in FIG. 3. Also, the processes of the present invention may be applied to a multiprocessor data processing system.

Data processing system 300 may take various forms, such as a stand alone computer or a networked computer. The depicted example in FIG. 3 and above-described examples are not meant to imply architectural limitations.

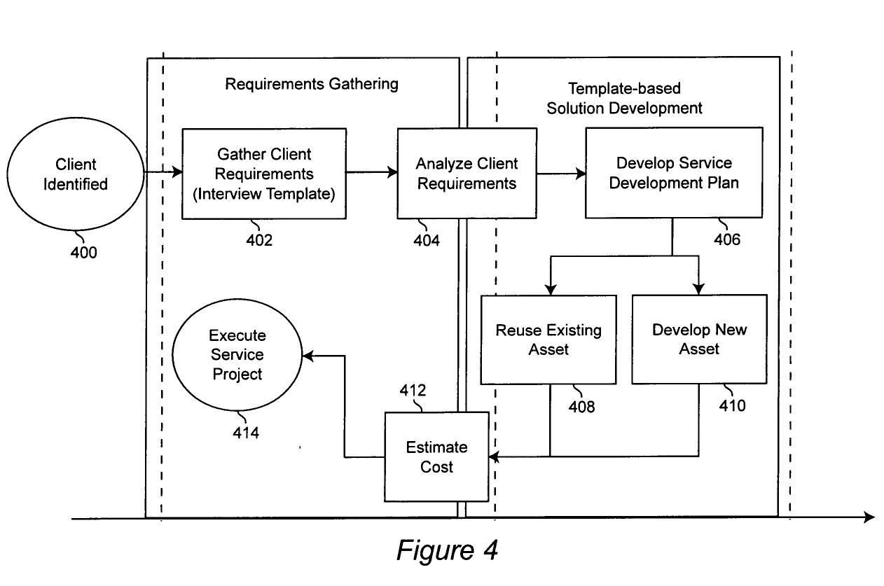

The approach, according to the present invention and as generally illustrated in FIG. 4, starts with a structured interview where customer's specific business processes and key configuration parameter values are captured. The client 400 is interviewed at block 402, using an interview template provided by the tool, to gather client requirements. The results of the client interview are analyzed to assist updating procedures and to configure the underlying solution template and pin-point additional development tasks at block 404, then a template-based solution development plan 406 is performed. In the course of developing a solution to the client's requirements, assets are analyzed and decisions are made as to whether an existing asset is to be reused, at block 408, or a new asset is to be developed, at block 410. The cost of the solution is estimated at block 412. During this process, the modeling details of the template-based standard service assets can be shared with the client to record any deviations and estimate service cost and pricing based on the client's service option selections. Finally, the services will be implemented by either configuring the solution template or developing new artifacts as needed. This is accomplished by execution of a service offering project at 414.

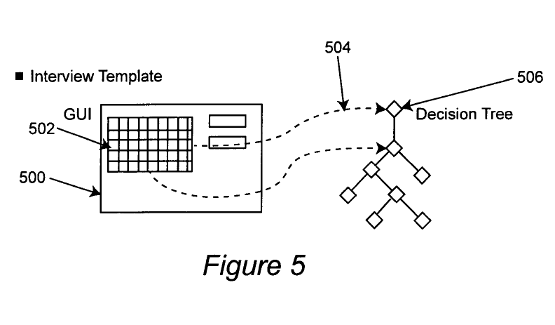

The requirements gathering is illustrated in FIG. 5 where a Graphic User Interface (GUI) screen 500 is used to capture the client's requirements for processes, systems, applications and data formats. The screen 500 displays a series of structured interview templates 502 which are used in the interview process. A series of blanks 504 are sequentially filled in during the interview process, and the information gathered by filling in these blanks is used to build a decision tree 506.

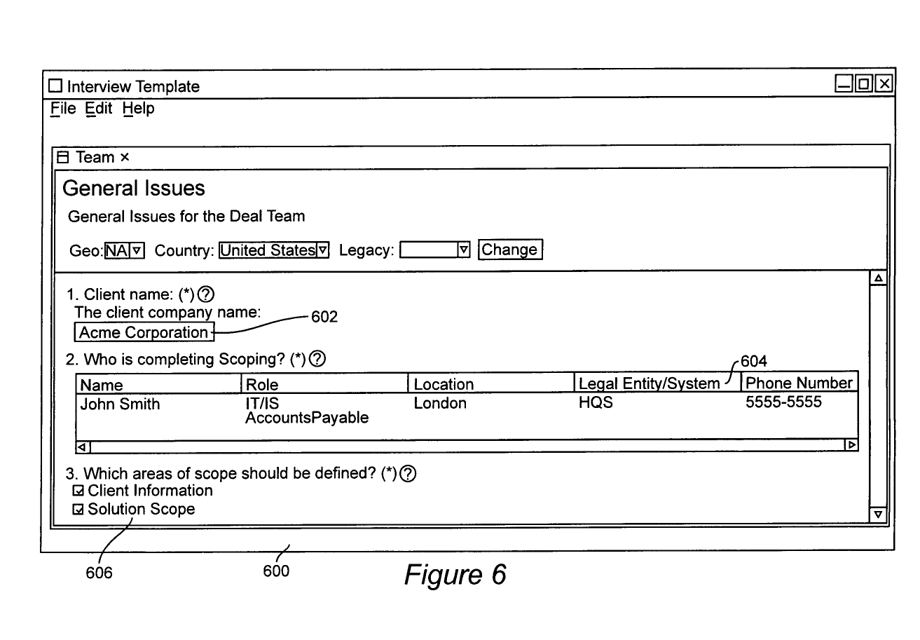

An example of an Interview Template is shown in FIG. 6 with the overall GUI screen 600 that consists of a set of questions to be answered during the interviews. The questions are of different types including input value 602, table input 604 and selections 606.

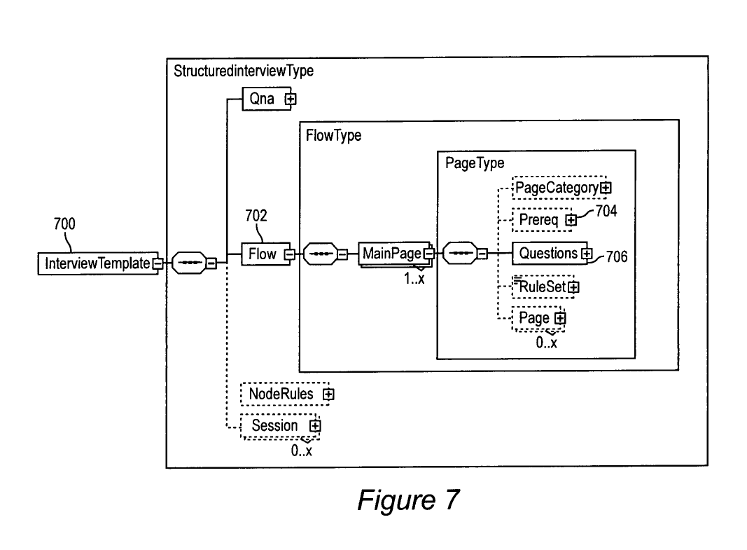

Underlying this GUI screen 600, there is a supporting decision tree defined by eXtensible Markup Language (XML) schema 700 as shown in FIG. 7. The decision tree is expressed with the flow 702 that determines the display of a particular set of questions 706 based on the evaluation of the PreReq 704.

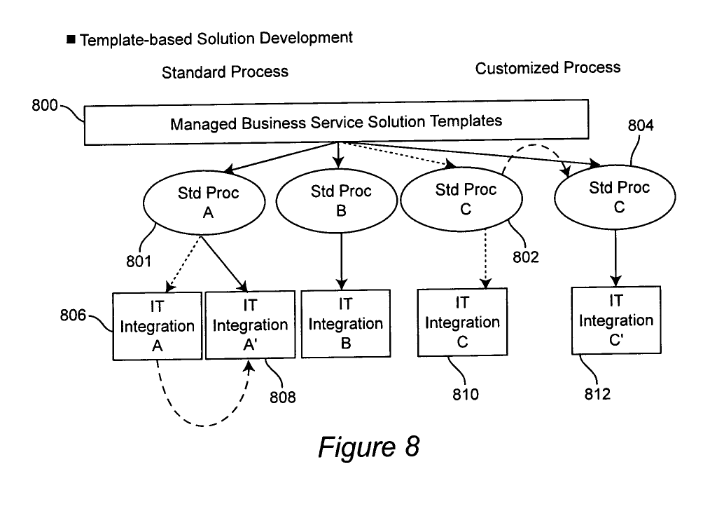

FIG. 8 shows in more detail the template-based solution development implemented by the invention. The managed business service solution template 800 consists of process templates 801 and 802 whose implementations are at the Information Technology (IT) level, and expressed as IT integration templates 806, 808 and 810. A process template 801 might have multiple alternative implementations 806 and 808. Furthermore, a process template 802 might be customized into derived template 804 to meet a client's specific requirements. As a result, the implementation IT integration template 810 would then be altered to integration template 812, reflecting the changes in the customized process template 804. By analyzing the client's requirements from the interview, it is possible to rapidly develop a solution for the client by customizing an existing service offering template. Also, we need to include business procedures and IT artifacts in the solution.

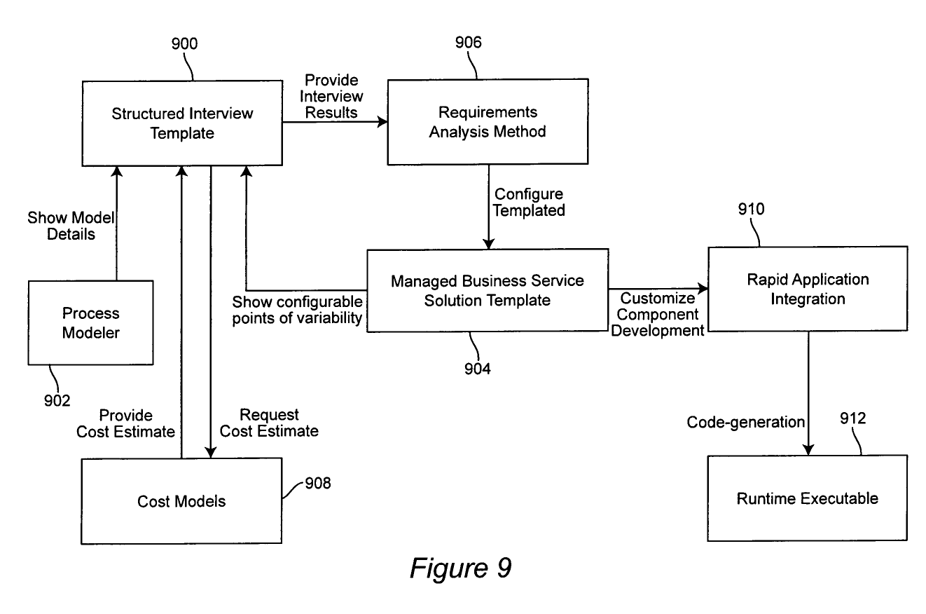

The underlying models supporting the approach according to the invention are illustrated in FIG. 9. The approach starts with completing Structured Interview Template 900 involving both the client and service provider. The Structured Interview Template 900 uses Process Modeler 902 for displaying process and business rule details, and shows the configurable points of variability in Managed Business Service Solution Template 904. As the Structured Interview Template 900 is being completed, it interacts with the Cost Model 908 to estimate the on-boarding cost. The result of the Structured Interview Template 900 will be analyzed by the Requirements Analysis Method 906, which, in turn, updates business procedures and configures the points of variability in the Managed Business Service Solution Template 904. The configured Solution Template 904 determines the components that require custom development, which will be realized by the Rapid Application Integration 910. The Rapid Application Integration 910 will then generate Runtime Executables 912.

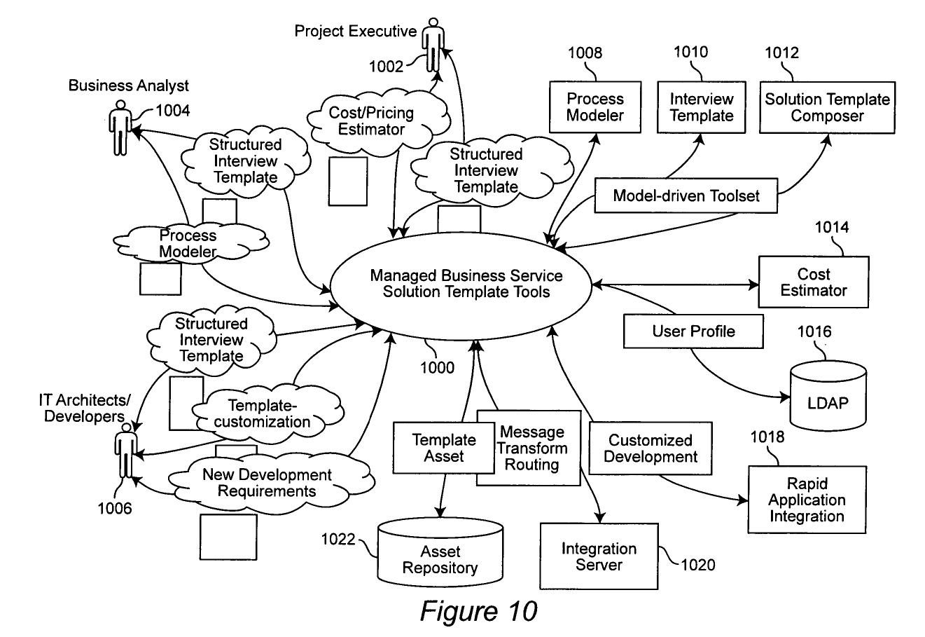

A sample implementation of the approach according to the invention is shown in the system diagram of FIG. 10. The primary users of the Managed Business Service Solution Template Tools 1000 include Project Executive 1002, Business Analyst 1004, and IT Architect/Developer 1006. The Tools 1000 consist of a Process Modeler 1008 for modeling business processes, Interview Template 1010 for supporting structured interviews, Solution Template Composer 1012 for constructing and configuring Managed Business Service Solution Templates, Cost Estimator 1014 for estimating overall cost, and Rapid Application Integration 1018 for developing and generating customized components. The Process Modeler 1008 is used to capture the standard business processes and their deviations. An example of a Process Modeler is the WebSphere Business Integration (WBI) Modeler, which is a standard IBM Software Group offering for modeling business operations and processes. The Solution Template Composer 1012 is an Eclipse-based tooling environment for composing and configuring process and integration solution templates. These templates include both business process and IT integration level templates in XML format. At business process level, the XML template file will capture WBI Modeler models and its templatized data (points of variability). The templates also capture IT level models including application configuration scripts and application adapters. The Cost Estimater 1014 estimates on-boarding costs. Its inputs are data from the Interview Template 1010, Solution Template Composer 1012 and task estimates by practioners. The access and usage of the Tools 1000 is controlled through LDAP (Lightweight Directory Access Protocol) server 1016. The LDAP 1016 is used for storing user profiles. It is used to authenticate the users of the tools when the tools and their content are to be used. For instance, the Web portal for installing the Interview Template 1010 uses the LPAD 1016 to store user profiles. The Rapid Application Integration 1018 includes Application Adapter (the adapter for interacting with client applications for integration in the form of WBI adapter and can be launched by integration platforms such as WBI Server Foundation products) and Application Configuration (a utility to convert business and IT requirements into configuration data/scripts used for automated or manual configuration of the application instance for the client). The runtime executables run on Integration Server 1020, which is used for application integration. For instance, IBM's WBI Express (InterChange) Server can be an Integration Hub. The Integration Server 1020 can also be served by other middleware products (e.g., M-based). The template assets are stored in and retrieved from Asset Repository 1022. The Asset Repository 1022 is a local repository fo9r capturing solution artifacts. It contains standard business processes and corresponding solution templates (SAP configuration scripts, MQ adaptors, etc.), collectively referred to as assets.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A model-driven solution template-based apparatus for managed business services wherein key assets of the business services are templatized and made configurable comprising:
a metamodel describing standard service offerings that can be configured to meet specific business and operational requirements at a level of business process and system components;
a set of tools to support and facilitate an on-boarding process including a structured way of capturing client data, analyzing the content of collected data, configuring solution templates, and a rapid application integration utility;
a cost and pricing model of service offerings that can help assess the service costs and resource requirements based on a client's selection of standard and customized processes and system components; and
a supporting system solution based upon underlying solution templates and solution artifacts as well as client-specific requirements.

2. The model-driven solution template-based apparatus for managed business services according to claim 1, wherein said set of tools comprises:
a process modeler used to capture standard business processes and their deviations;
an interview template used to capture a client's requirements for processes, systems, applications and data formats; and
a solution template for composing and configuring process and integration solution templates.

3. The model-driven solution template-based apparatus for managed business services according to claim 2, wherein the solution template composer composes and configures business processes and Information Technology (IT) integration level templates in eXtensible Markup Language (XML) format.

4. The model-driven solution template-based apparatus for managed business services according to claim 2, further comprising a database server for storing user profiles to authenticate users of the set of tools and controlling when contents of the set of tools are to be used.

5. The model-driven solution template-based apparatus for managed business services according to claim 4, wherein the database server is a Lightweight Directory Access Protocol (LDAP) server.

6. The model-driven solution template-based apparatus for managed business services according to claim 2, wherein the supporting system solution comprises:
a rapid application integration module including an application adapter for interacting with client applications and an application configuration utility to convert business and Information Technology (IT) requirements into configuration data/scripts used for automated or manual configuration of an application instance for the client;
an integration server used for application integration; and
an asset repository for capturing solution artifacts.

7. A computer assisted method providing a model-driven solution template-based approach for managed business services comprising the steps of:
gathering client requirements using an interview template to generate a decision tree;
analyzing client requirements using a requirements analysis model based on the decision tree generated by gathering client requirements;
developing a managed business service template based on analyzing client requirements, said business service template being configured to incorporate customized templates specific to the client's requirements;
estimating cost of a solution generated by the developed managed business service template using a cost and pricing model of service offerings; and
using the developed managed business service template to generate runtime executable code to implement the business solution for the client.

8. The computer assisted method providing a model-driven solution template-based approach for managed business services according to claim 7, wherein the step of gathering client requirements using an interview template is performed with the aid of a Graphic User Interface (GUI) screen consisting of a set of questions to be answered during an interview, the GUI screen being supported by an underlying decision tree defined by an eXtensible Markup Language (XML) schema.

9. The computer assisted method providing a model-driven solution template-based approach for managed business services according to claim 7, wherein the steps of analyzing client requirements and developing a managed business service template are performed with a set of tools including a process modeler that captures standard business processes and their deviations and a solution template composer for composing and configuring process and integration solution templates in eXtensible Markup Language (XML) format.
